(19) United States
(12) Patent Application Publication
(10) Pub. No.: US 2024/0411671 A1
(43) Pub. Date: Dec. 12, 2024

(54) TEST CASE MANAGEMENT SYSTEM FOR A LARGE SOFTWARE SYSTEM

(71) Applicant: Dell Products L.P., Round Rock, TX (US)

(72) Inventors: Changxu Jiang, Chengdu (CN); Robin Fei Wang, Chengdu (CN)

(73) Assignee: Dell Products L.P., Round Rock, TX (US)

(21) Appl. No.: 18/646,954

(22) Filed: Apr. 26, 2024

(30) Foreign Application Priority Data
Jun. 7, 2023 (CN) 202310673671.3

(51) Int. Cl. G06F 11/36

(52) U.S. Cl. CPC G06F 11/3676; G06F 11/3688

(57) ABSTRACT

Methods, system, and non-transitory processor-readable storage medium for test case management system are provided herein. An example method includes identifying, by the test case management system, a namespace for inclusion of test features required to provide test coverage in a software test life cycle system. The test case management system creates a test case feature matrix data set for test cases in a test case suite. The test case management system performs a similarity analysis between the test features in the namespace and the test cases in the test case suite, using the test case feature matrix data set, to identify a subset of the test cases that provide at least a portion of the test coverage. The software test life cycle system executes the subset of the test cases on a test system to provide at least a portion of the test coverage.

### FIELD

The field relates generally to optimizing test coverage, and more particularly to optimizing test coverage in information processing systems.

### BACKGROUND

Customers demand high quality software, and adequate test coverage is one component of software quality. Comprehensive and balanced test coverage of software while selectively choosing a subset of the large number of available test cases to provide that balanced test coverage, therefore, is critical to the success of a software project.

### SUMMARY

Illustrative embodiments provide techniques for implementing a test case management system in a storage system. For example, illustrative embodiments identify, by the test case management system, a namespace for inclusion of test features required to provide test coverage in a software test life cycle system. The test case management system creates a test case feature matrix data set for test cases in a test case suite. The test case management system performs a similarity analysis between the test features in the namespace and the test cases in the test case suite, using the test case feature matrix data set, to identify a subset of the test cases that provide at least a portion of the test coverage. The software test life cycle system executes the subset of the test cases on a test system to provide at least a portion of the test coverage. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including a test case management system in an illustrative embodiment.

FIG. 2 shows a flow diagram of a process for a test case management system in an illustrative embodiment.

FIGS. 3 and 4 show examples of processing platforms that may be utilized to implement at least a portion of a test case management system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a test case management system, which technique may be used to provide, among other things, test coverage by efficiently using available test cases by identifying, by the test case management system, a namespace for inclusion of test features required to provide test coverage in a software test life cycle system. The test case management system creates a test case feature matrix data set for test cases in a test case suite. The test case management system performs a similarity analysis between the test features in the namespace and the test cases in the test case suite, using the test case feature matrix data set, to identify a subset of the test cases that provide at least a portion of the test coverage. The software test life cycle system executes the subset of the test cases on a test system to provide at least a portion of the test coverage.

The productivity of software development processes is constantly rising as customers demand effective functionality, and increasingly higher quality. The feature coverage of test software is critical to the success of software projects. Software projects are increasingly expanding, incrementally developing new features that require testing, as well as adding functionality to previous software releases. Engineering teams develop new test cases to test out the new functionality as well as rerunning regression test cases. This means that new test cases that provide additional feature coverage are constantly needed within the software testing life cycle (STLC), where the STLC is a sequence of activities that occur during software testing.

The results of the new test cases and the regression test cases are the DoD (Definition of Done) criteria to integrate the feature code into the integration code branch. Even after this integration step is completed, a very large number of system and integration tests are needed to assure quality for a complex software system, especially a large storage system. Even when code changes are made to one of the sub-components that supports one new feature, there may be dozens of new test cases and hundreds of regression test cases that need to be executed to verify that code change. Eventually, the new test cases are automated and added to the regression test suite. As the number of test cases grows, so does the time duration needed to complete execution as well as the consumption of other resources (i.e., machines, expensive target hardware, storage systems, etc.).

When new features are introduced, typically new test cases are developed to test the new features. As times goes on, the total number of test cases grows, as does the likelihood that there are duplicating test efforts within the large repository of test cases. It would be ideal to identify similar existing test cases that test the new features. The identified similar test cases could be enhanced to test the new features, serve as a basis for the creation of the new test cases, and/or similar test cases could be merged together. For example, the existing test cases may identify existing configurations, steps and/or functions that can aid in testing design and/or automation.

Manually reviewing the large repository of test cases to identify a subset of these similar test cases that provide test feature coverage for a large amount of test features often takes too much time and may not even be comprehensive enough to provide the necessary feature coverage.

Conventional technologies for identifying test cases that provide similar test feature coverage do not provide an automated process that outputs test cases that provide feature coverage from a very large number of test cases. Conventional technologies do not provide a customizable process that is also scalable. Conventional technologies do not provide a system that allows users to tune the weights of the test features to increase and/or decrease the importance of particular features. Conventional technologies do not allow users to specify how many similar test cases are outputted as results. Conventional technologies do not provide a system that analyzes the relevance of test cases with respect to other test cases to reduce overlapping efforts, and reduce duplication of test efforts. Conventional technologies do not provide a reference to the global feature coverage of a group of test cases.

By contrast, in at least some implementations in accordance with the current technique as described herein, feature coverage is optimized by efficiently using available test cases by identifying, by the test case management system, a namespace for inclusion of test features required to provide test coverage in a software test life cycle system. The test case management system creates a test case feature matrix data set for test cases in a test case suite. The test case management system performs a similarity analysis between the test features in the namespace and the test cases in the test case suite, using the test case feature matrix data set, to identify a subset of the test cases that provide at least a portion of the test coverage. The software test life cycle system executes the subset of the test cases on a test system to provide at least a portion of the test coverage.

Thus, a goal of the current technique is to provide a method and a system for providing a test case management system that delivers an automated process that outputs test cases that provide feature coverage from among a very large number of test cases. Another goal is to provide a customizable process that is also scalable. Another goal is to provide a system that allows users to tune the weights of the test features to increase and/or decrease the importance of particular features. Another goal is to allow users to specify how many similar test cases should be outputted as results. Another goal is to provide a system that analyzes the relevance of test cases with respect to other test cases to reduce overlapping efforts, and reduce duplication of test efforts. Another goal is to provide a reference to the global feature coverage of a group of test cases. Yet another goal is to provide a system where the scalability of the number of features in the namespace and the number of test cases in the test suite reduce the interference of other factors, and facilitate the targeting of specific test features as opposed to filtering the entire pool of test cases.

In at least some implementations in accordance with the current technique described herein, the use of a test case management system can provide one or more of the following advantages: provides an automated process that outputs test cases that provide feature coverage from among a very large number of test cases, provides a customizable process that is also scalable, provides a system that allows users to tune the weights of the test features to increase and/or decrease the importance of particular features, allows users to specify how many similar test cases should be outputted as results, provides a system that analyzes the relevance of test cases with respect to other test cases to reduce overlapping efforts, and reduce duplication of test efforts, provides a reference to the global feature coverage of a group of test cases, and provides a system where the scalability of the number of features in the namespace and the number of test cases in the test suite reduce the interference of other factors, and facilitate the targeting of specific test features as opposed to filtering the entire pool of test cases.

In contrast to conventional technologies, in at least some implementations in accordance with the current technique as described herein, test feature coverage is optimized by efficiently using available test cases by identifying, by the test case management system, a namespace for inclusion of test features required to provide test coverage in a software test life cycle system. The test case management system creates a test case feature matrix data set for test cases in a test case suite. The test case management system performs a similarity analysis between the test features in the namespace and the test cases in the test case suite, using the test case feature matrix data set, to identify a subset of the test cases that provide at least a portion of the test coverage. The software test life cycle system executes the subset of the test cases on a test system to provide at least a portion of the test coverage.

In an example embodiment of the current technique, the test case management system receives a request to identify a subset of the test cases that provide test coverage in a software test lifecycle system.

In an example embodiment of the current technique, the test case management system identifies a plurality of essential test features required to provide the test coverage in the software testing life cycle system.

In an example embodiment of the current technique, the test case management system identifies at least one of a new namespace and an existing namespace.

In an example embodiment of the current technique, the test case management system identifies a feature pool comprising a plurality of test features that are tested by a plurality of test cases, identifies the test features from the feature pool that are required to provide the test coverage, and adds the test features required to provide test coverage from the feature pool to the namespace.

In an example embodiment of the current technique, the test case management system initializes weights for at least one of the test features in the namespace.

In an example embodiment of the current technique, the test case management system tunes at least one of the initialized weights in the namespace.

In an example embodiment of the current technique, the test case management system performs at least one of increasing weights for at least one of the initialized weights for test features that are more relevant to providing the test coverage and decreasing weights for at least one of the initialized weights for test features that are less relevant to providing the test coverage.

In an example embodiment of the current technique, the test case management system sets the weights for at least one of the test features in the namespace to a default weight.

In an example embodiment of the current technique, the test case management system creates a feature map repository for the test cases in the test case suite, where the feature map repository identifies feature coverage provided by each of the test cases.

In an example embodiment of the current technique, the test case management system generates the test case feature matrix data set using the feature map repository.

In an example embodiment of the current technique, the test case management system assigns a binary representation for each feature to each test case, where the binary representation indicates whether the test case provides the feature coverage for each feature in the namespace.

In an example embodiment of the current technique, the test case management system assigns a random number of the test cases in a plurality of test cases to the test case suite.

In an example embodiment of the current technique, the test case management system calculates a number of elements in each row of the test case feature matrix data set, where the number of elements indicates feature representation by a respective test case.

In an example embodiment of the current technique, the test case management system determines the number of elements in each row of the test case feature matrix data does not meet a threshold, and determines there is inadequate feature coverage in the test cases in the test case suite.

In an example embodiment of the current technique, the test case management system determines the number of elements in each row of the test case feature matrix data equals zero, determines there is no feature coverage in the test cases in the test case suite, and performs at least one of adding additional test cases to the test case suite and replacing at least one of the test cases in the test case suite with another at least one test case.

In an example embodiment of the current technique, the test case management system identifies a quantity of test cases that should be in the subset of the test cases that provide at least a portion of the test coverage.

In an example embodiment of the current technique, the test case management system sorts results of the similarity analysis to identify the most relevant test cases in the test case suite, selects the quantity of the top sorted most relevant test cases to be in the subset of the test cases, and outputs the subset of the test cases.

In an example embodiment of the current technique, the test case management system identifies an index associated with each of the top sorted most relevant test cases, and maps the index in the test case suite to the respective test case to identify each test case in the subset of the test cases.

In an example embodiment of the current technique, the test case management system provides the subset of the test cases to the software test lifecycle system for execution of the subset of the test cases.

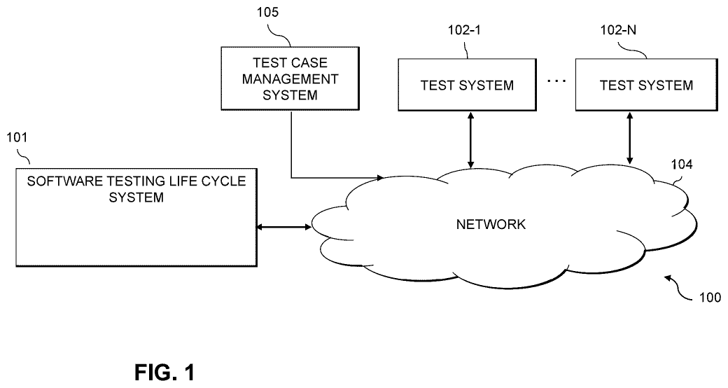

FIG. 1 shows a computer network (also referred to herein as an information processing system) 100 configured in accordance with an illustrative embodiment. The computer network 100 comprises a software testing life cycle system 101, test case management system 105, and test systems 102-N. The software testing life cycle system 101, test case management system 105, and test systems 102-N are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a test case management system 105 that may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the test systems 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The test systems 102-N in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the test case management system 105 are one or more input-output devices, which illustratively comprise keyboards, displays or other types of input-output devices in any combination. Such input-output devices can be used, for example, to support one or more user interfaces to the test case management system 105, as well as to support communication between the test case management system 105 and other related systems and devices not explicitly shown. For example, a dashboard may be provided for a user to view a progression of the execution of the test case management system 105. One or more input-output devices may also be associated with any of the test systems 102-N.

Additionally, the test case management system 105 in the FIG. 1 embodiment is assumed to be implemented using at least one processing device. Each such processing device generally comprises at least one processor and an associated memory, and implements one or more functional modules for controlling certain features of the test case management system 105.

More particularly, the test case management system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the test case management system 105 to communicate over the network 104 with the software testing life cycle system 101, and test systems 102-N and illustratively comprises one or more conventional transceivers.

A test case management system 105 may be implemented at least in part in the form of software that is stored in memory and executed by a processor, and may reside in any processing device. The test case management system 105 may be a standalone plugin that may be included within a processing device.

It is to be understood that the particular set of elements shown in FIG. 1 for test case management system 105 involving the software testing life cycle system 101, and test systems 102-N of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the test case management system 105 can be on and/or part of the same processing platform.

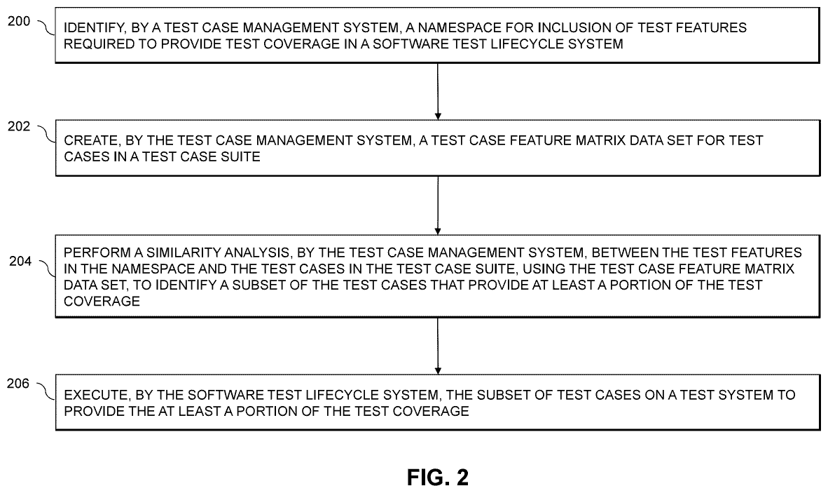

An exemplary process of test case management system 105 in computer network 100 will be described in more detail with reference to, for example, the flow diagram of FIG. 2.

FIG. 2 is a flow diagram of a process for execution of the test case management system 105 in an illustrative embodiment. It is to be understood that this particular process is only an example, and additional or alternative processes can be carried out in other embodiments.

In an example embodiment, the test case management system 105 receives a request to identify a subset of a plurality of test cases that provide test coverage in a software test lifecycle system 101. For example, a new feature is added to a product, and test coverage for that new feature needs to be added to the plurality of test cases. In an example embodiment, the test case management system 105 identifies a plurality of essential test features required to provide the test coverage in the software testing life cycle system 101 for the new feature. The test case management system 105 identifies test cases that provide the required test coverage, or identifies test cases that are similar enough that those test cases can be modified to provide the required test coverage, or serve as a basis for creating new test cases that provide the required test coverage. In an example embodiment, the test case management system 105 provides an efficient way to quickly analyze the relevance of test cases with respect to other test cases to avoid executing redundant test cases that provide overlapping test feature coverage, and as a result, reduces duplicate work.

In an example embodiment, the test case management system 105 comprises a feature pool of test cases. In an example embodiment, the test case management system 105 identifies a feature pool comprising a plurality of test features that are tested by a plurality of test cases. In an example embodiment, the test case management system 105 identifies the test features from the feature pool that are required to provide the test coverage (i.e., the plurality of essential test features required to provide the test coverage in the software testing life cycle system 101), and adds the test features required to provide test coverage from the feature pool to the namespace. In an example embodiment, test features may be added and/or removed from the feature pool.

At 200, the test case management system 105 identifies a namespace for inclusion of test features required to provide test coverage in a software test life cycle system 101. In an example embodiment, the namespace is a list of test features. In an example embodiment, the features in the namespace are a subset of the features in the feature pool, and are used to generate a test case feature matrix data set. In an example embodiment, the test case management system 105 identifies a new namespace or leverages an existing namespace.

In an example embodiment, a user may identify the namespace to be created. The namespace contains the features that are used in the similarity analysis. Essentially, the namespace contains the features that a user cares about, for example, what a new test case should cover. Thus, when the test case management system 105 outputs test cases that provide the desired feature coverage, the user may utilize those test cases for testing, or use those test cases as a basis for creating a new test case that provides the desired feature coverage. In an example embodiment, there may be visual representation of the feature pool, and/or namespace and a drag and drop feature where users may select features from the feature pool, and drag them to the namespace. In an example embodiment, a user may select features from the feature pool, and add them to the namespace for a similarity analysis. In an example embodiment, the namespace may also contain adjustable weights associated with at least some of the features in the namespace.

At 202, the test case management system creates a test case feature matrix data set for test cases in a test case suite. The test case suite is a subset of the plurality of test cases. In an example embodiment, the test cases in the test case suite may come from multiple product components. In an example embodiment, a random number of the test cases in the plurality of test cases may be assigned to the test case suite.

At 204, the test case management system 105 performs a similarity analysis between the test features in the namespace and the test cases in the test case suite, using the test case feature matrix data set, to identify a subset of the test cases that provide at least a portion of the test coverage. The similarity analysis module determines which test cases from one or more test suites that are most useful and/or similar to a new test case.

In an example embodiment, the test case management system 105 creates a feature map repository for the test cases in the test case suite, where the feature map repository identifies feature coverage provided by each of the test cases. In an example embodiment, the test case management system 105 assigns a binary representation for each feature to each test case, where the binary representation indicates whether each test case provides the feature coverage for each feature in the namespace. For example, if a test case provides feature coverage for a particular feature, the associated value in the repository is “True” or “1”, and if the test case does not provide feature coverage, the associated value in the repository is “False” or “0”. In an example embodiment, the default value for all features associated with all test cases is “False” or “0”. In an example embodiment, the test case management system 105 generates a feature map for each test case, and records them in the feature map repository with at least a test case ID, and the corresponding feature. For example:

| | | | | |
|---|---|---|---|---|
| Test Case ID | Feature 1 | Feature 2 | . . . | Feature X |

| | | | |
|---|---|---|---|
| Test Case 1 | 0 | 1 | 1 |
| Test Case 2 | 0 | 0 | 1 |
| . . . | | | |
| Test Case N | 1 | 1 | 0 |

In an example embodiment, the feature map also records an index associated with each respective Test Case ID. For example:

| Index of Test Case Suite 1 | Test Case ID |
|---|---|
| 1 | Test Case 5 |
| 2 | Test Case 8 |
| . . . | |
| I₁ | Test Case X |

In an example embodiment, when a new test case is added to the feature map repository, a user is required to set the feature coverage values for all features associated with the newly added test case. In an example embodiment, users may also modify at least some of the feature coverage values in the feature map repository. In an example embodiment, the feature coverage status for each test case is recorded in the feature map repository.

In an example embodiment, the test case management system 105 generates the test case feature matrix data set using the feature map repository according to the test cases that are in the test suite. In an example embodiment, a user would specify which test case (or test cases) to use for the similarity analysis.

In an example embodiment, “N” is the number of features in the namespace that is to be analyzed, “I” is the number of test cases to be analyzed in the test suite, and “f” is the feature ID list for the namespace that is to be analyzed, where f=[f₁, f₂, . . . f_{N}], and fₙ is the identity of feature n. Filtering the features in the namespace and the scope of the test suite reduce the interference of other factors, and facilitate targeting the desired feature coverage among many, many features tested within the large amount of test cases in the test case pool.

The test case feature matrix data set, “D” is D=[d₁, d₂, . . . dᵢ . . . , d_{I},], where dᵢ is the i^{th} column in matrix D, i is the testcase id in the test suite, “I” is the number of test cases in the test suite, and dᵢ=[d₁, d₂, . . . , d_{N}]^{T} represents the feature map for test case i, where dₙ is equal to 1 if the test case i has a test point or test coverage for feature n. In this example scenario, “T” stands for vector or matrix transpose:

$${d}_{i} = {[ {d}_{1} , {d}_{2} , ... , {d}_{N} ]}^{T} = ( \begin{matrix}{d}_{1} \\ {d}_{2} \\ ...\end{matrix} )$$

$$[ {w}_{1} , {w}_{2} , {w}_{3} ] \cdot {[ {d}_{1} , {d}_{2} , {d}_{3} ]}^{T} = ( {w}_{1} , {w}_{2} , {w}_{3} ) ( \begin{matrix}{d}_{1} \\ {d}_{2} \\ {d}_{3}\end{matrix} ) = {w}_{1} \cdot {d}_{1} + {w}_{2} \cdot {d}_{2} + {w}_{3} \cdot {d}_{3}$$

In an example embodiment, weights are used to aggregate similarity in accordance with the feature ID list for the namespace that is to be analyzed, (as noted above, represented by “f”). In an example embodiment, the test case management system 105 initializes weights for at least one of the test features in the namespace. For example, the weights may be represented by W=[w₁, w₂, . . . w_{N}] for a given namespace, where wᵢ corresponds to the weight of fᵢ and where f=[f₁, f₂, . . . f_{N}], and fₙ is the identity of feature n. Feature=f and weight=W and they both are ∈R^{N×1}. In an example embodiment, the weights for one or more of the test features in the namespace may be set to a default weight, such as “1. In another example embodiment, weights may be set to “0” for one or more features if a user wants to filter out results without the influence of a particular feature (i.e., the one or more features that have been set to “0”). In an example embodiment, a user may modify, or tune one or more of the initialized weights in the namespace. For example, the user may increase the weights of one or more of the initialized weights for test features that are more relevant to providing the test coverage, and/or decrease the weights of one or more of the initialized weights for test features that are less relevant to providing the test coverage. For example, if the user wants to identify test cases provide feature coverage for the features of f₂—‘late dedupe’, f₆—‘NDU, f₈—‘VLB defrag’ and f₉—‘node reboot fault’, then the user increases the weights of W₂, W₆, W₈ and W₉. The user may also adjust the weight values of other features to, for example, zero, if the user wants to filter out results without the influence of those features (that have been reset to zero).

In an example embodiment, the normalized weights are represented by W̅, where W̅=[w̅₁̅, w̅₂̅, . . . , w̅_̅{̅N̅}̅] and

$$\overline{{w}_{n}} = \frac{{w}_{n}}{{\sum }_{n = 1}^{N} {w}_{n}} where W ∈ {R}^{N \times 1}$$

In this example scenario, W∈R^{N×1} represents array W as an N dimensional real space transversal vector. The length of W is N, and R represents a set of real numbers. For example, [w₁, w₂, w₃]∈R^{3×1}.

In an example embodiment, S represents the aggregated similarity values for the test cases in the test suite, where S=[s₁, s₂, . . . , s_{I}], sᵢ=W̅·dᵢ and

$$S = \overline{W} \cdot D = [ \overline{W} \cdot {d}_{1} , \overline{W} \cdot {d}_{2} , \overline{W} \cdot {d}_{3} , ... , ... , \overline{W} \cdot {d}_{I} ]$$

In this example scenario, the larger the value of S₁ is, the more similarity is present in the test cases.

In an example embodiment, the similarity analysis (i.e., the feature coverage result of the test suite using the features in the namespace) may be represented by the sum of the elements in each row of the test case feature matrix data set “D”. In other words, the test case management system 105 calculates a number of elements in each row of the test case feature matrix data set, where the number of elements indicates feature representation by a respective test case. The feature coverage of the test cases in the test suite may be determined by the sum of the elements in each row of the test case feature matrix data set “D”. The n^{th} row of D represents the coverage for feature n. Thus, if the sum equals zero, this means the coverage of feature n is missing. Likewise, if the sum is a low number, this may indicate that, while there is some feature coverage, it might not be enough to thoroughly test feature n, and there may be other test cases that need to be added to the test suite to increase the results of the similarity analysis.

In an example embodiment, the test case management system 105 determines the number of elements in each row of the test case feature matrix data does not meet a threshold. This means the test cases in the test suite do not provide adequate feature coverage. In this example scenario, a user may have to add, remove, and/or replace test cases in the test suite so that more test cases in the test suite provide the feature coverage for the essential features that are in the namespace.

In an example embodiment, the test case management system 105 determines the number of elements in each row of the test case feature matrix data equals zero. This means there is no feature coverage in the test cases in the test case suite. In this example scenario, a user may add and/or replace additional test cases in the test case suite.

When the test case management system 105 outputs test cases that provide feature coverage, a user may use those test cases to test the essential features, or may enhance those existing tests to provide the required feature coverage. If the test case management system 105 determines that there are no test cases that provide the essential feature coverage, then a user may have to create at least one new test case from one or more of the existing test cases. Either way, the test case management system 105 reduces duplicate work by identifying these baseline test cases that may be used as a basis for new test cases.

In an example embodiment, users may adjust the test cases in the test suite by adding or replacing test cases in the test suite. If, for example, there are not enough test cases that provide the feature coverage for the feature “n”, users may add test cases where dₙ equals 1 (meaning those test cases provide feature coverage for feature “n”) to enhance/improve the results of the similarity analysis.

In an example embodiment, the test case management system 105 identifies a quantity of test cases that should be in the subset of the test cases that provide at least a portion of the test coverage. For example, a user may specify how many test cases that have the most similarity should be outputted as a result of the similarity analysis. In an example embodiment, “M” is a variable integer number that represents the number of test cases that should be outputted. A user may also trigger the similarity analysis to execute on the test suite using the features in the namespace. For example, if the user selects that “M” equals three, the output of the similarity analysis is the three test cases that have the most similarity with the features in the namespace. By checking the feature map (d) of these three test cases, a user could determine whether it is necessary to create a new test case, of if these three test cases could be enhanced to provide the necessary feature coverage, instead of creating a new test case.

In an example embodiment, the test case management system 105 sorts the results of the similarity analysis to identify the most relevant test cases in the test case suite, and selects the quantity of the top sorted most relevant test cases to be in the subset of the test cases. For example, if “M” is determined to be “3”, then the test case management system 105 sorts the results of the similarity analysis to determine the top 3 test cases of the similarity analysis, and outputs the subset of the test cases.

In an example embodiment, the test case management system 105 identifies an index associated with each of the top sorted most relevant test cases, and maps the index in the test case suite to the respective test case to identify each test case in the subset of the test cases. In other words, the test case management system 105 sorts the results of the similarity analysis to find the top “M” elements, and records their indexes. The test case management system 105 then outputs the corresponding test cases according to the indexes. In an example embodiment, the objective function is used to find the indexes of the test cases with the top “M” similarity values:

$$ObjectFunc : {arg}_{M} {max}_{i ∈ \{ 1 , 2 , ... , I \}} {s}_{i}$$

In an example embodiment, the test case management system 105 provides the subset of the test cases to the software test life cycle system 101 for execution of the subset of the test cases. At 206, the software test life cycle system 101 executes the subset of the test cases on a test system 102-N to provide at least a portion of the test coverage.

Accordingly, the particular processing operations and other functionality described in conjunction with the flow diagram of FIG. 2 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to significantly improve selection of test cases to provide desired feature coverage. These and other embodiments can effectively and efficiently improve test coverage and testing times relative to conventional approaches. For example, embodiments disclosed herein provide an automated process that outputs test cases that provide feature coverage from among a very large number of test cases. Embodiments disclosed herein provide a customizable process that is also scalable. Embodiments disclosed herein provide a system that allows users to tune the weights of the test features to increase and/or decrease the importance of particular features. Embodiments disclosed herein allow users to specify how many similar test cases should be outputted as results. Embodiments disclosed herein provide a system that analyzes the relevance of test cases with respect to other test cases to reduce overlapping efforts, and reduce duplication of test efforts. Embodiments disclosed herein provide a reference to the global feature coverage of a group of test cases. Embodiments disclosed herein provide a system where the scalability of the number of features in the namespace and the number of test cases in the test suite reduce the interference of other factors, and facilitate the targeting of specific test features as opposed to filtering the entire pool of test cases.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

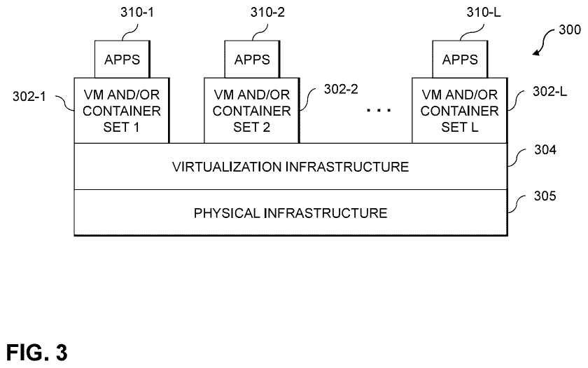

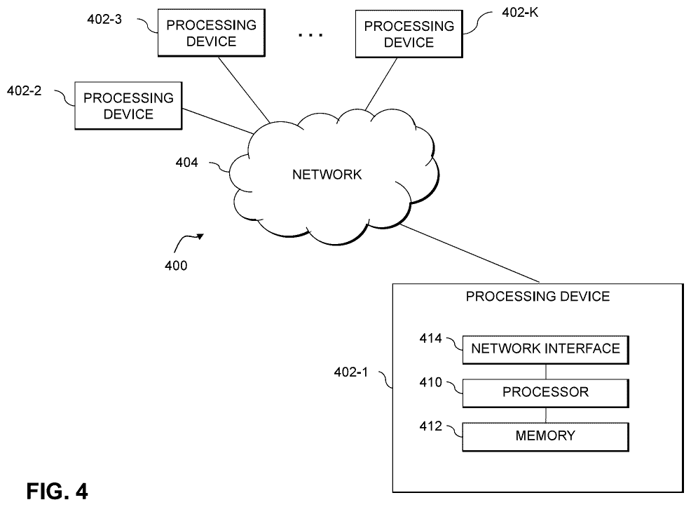

Illustrative embodiments of processing platforms will now be described in greater detail with reference to FIGS. 3 and 4. Although described in the context of the information processing system 100, these platforms may also be used to implement at least portions of other information processing systems in other embodiments.

FIG. 3 shows an example processing platform comprising cloud infrastructure 300. The cloud infrastructure 300 comprises a combination of physical and virtual processing resources that are utilized to implement at least a portion of the information processing system 100. The cloud infrastructure 300 comprises multiple virtual machines (VMs) and/or container sets 302-1, 302-2, . . . 302-L implemented using virtualization infrastructure 304. The virtualization infrastructure 304 runs on physical infrastructure 305, and illustratively comprises one or more hypervisors and/or operating system level virtualization infrastructure. The operating system level virtualization infrastructure illustratively comprises kernel control groups of a Linux operating system or other type of operating system.

The cloud infrastructure 300 further comprises sets of applications 310-1, 310-2, . . . 310-L running on respective ones of the VMs/container sets 302-1, 302-2, . . . 302-L under the control of the virtualization infrastructure 304. The VMs/container sets 302 comprise respective VMs, respective sets of one or more containers, or respective sets of one or more containers running in VMs. In some implementations of the FIG. 3 embodiment, the VMs/container sets 302 comprise respective VMs implemented using virtualization infrastructure 304 that comprises at least one hypervisor.

A hypervisor platform may be used to implement a hypervisor within the virtualization infrastructure 304, where the hypervisor platform has an associated virtual infrastructure management system. The underlying physical machines comprise one or more distributed processing platforms that include one or more storage systems.

In other implementations of the FIG. 3 embodiment, the VMs/container sets 302 comprise respective containers implemented using virtualization infrastructure 304 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 300 shown in FIG. 3 may represent at least a portion of one processing platform. Another example of such a processing platform is processing platform 400 shown in FIG. 4.

The processing platform 400 in this embodiment comprises a portion of the information processing system 100 and includes a plurality of processing devices, denoted 402-1, 402-2, 402-3, . . . 402-K, which communicate with one another over a network 404.

The network 404 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 402-1 in the processing platform 400 comprises a processor 410 coupled to a memory 412.

The processor 410 comprises a microprocessor, a microcontroller, an application-specific integrated circuit (ASIC), a field-programmable gate array (FPGA) or other type of processing circuitry, as well as portions or combinations of such circuitry elements.

The memory 412 comprises random access memory (RAM), read-only memory (ROM) or other types of memory, in any combination. The memory 412 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 402-1 is network interface circuitry 414, which is used to interface the processing device with the network 404 and other system components, and may comprise conventional transceivers.

The other processing devices 402 of the processing platform 400 are assumed to be configured in a manner similar to that shown for processing device 402-1 in the figure.

Again, the particular processing platform 400 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
identifying, by a test case management system, a namespace for inclusion of test features required to provide test coverage in a software test life cycle system;
creating, by the test case management system, a test case feature matrix data set for test cases in a test case suite;
performing a similarity analysis, by the test case management system, between the test features in the namespace and the test cases in the test case suite, using the test case feature matrix data set, to identify a subset of the test cases that provide at least a portion of the test coverage; and
executing, by the software test life cycle system, the subset of the test cases on a test system to provide the at least a portion of the test coverage, wherein the method is implemented by at least one processing device comprising a processor coupled to a memory.

2. The method of claim 1 wherein identifying the namespace comprises:
identifying a plurality of essential test features required to provide the test coverage in the software testing life cycle system.

3. The method of claim 1 wherein identifying the namespace comprises:
identifying at least one of a new namespace and an existing namespace.

4. The method of claim 1 wherein identifying the namespace comprises:
identifying a feature pool comprising a plurality of test features that are tested by a plurality of test cases;
identifying the test features from the feature pool that are required to provide the test coverage; and
adding the test features required to provide test coverage from the feature pool to the namespace.

5. The method of claim 1 wherein identifying the namespace comprises:
initializing weights for at least one of the test features in the namespace.

6. The method of claim 5 further comprising:
tuning at least one of the initialized weights in the namespace.

7. The method of claim 6 wherein tuning the at least one of the initialized weights in the namespace comprises at least one of:
increasing weights for the at least one of the initialized weights for test features that are more relevant to providing the test coverage; and
decreasing weights for the at least one of the initialized weights for test features that are less relevant to providing the test coverage.

8. The method of claim 5 wherein initializing the weights for the at least one of the test features in the namespace comprises:
setting the weights for the at least one of the test features in the namespace to a default weight.

9. The method of claim 1 wherein creating the test case feature matrix data set for test cases in the test case suite comprises:
creating a feature map repository for the test cases in the test case suite, wherein the feature map repository identifies feature coverage provided by each of the test cases.

10. The method of claim 9 further comprising:
generating the test case feature matrix data set using the feature map repository.

11. The method of claim 9 wherein creating the feature map repository for the test cases in the test case suite comprises:
assigning a binary representation for each feature to each test case, wherein the binary representation indicates whether the each test case provides the feature coverage for the each feature in the namespace.

12. The method of claim 9 wherein creating the feature map repository for the test cases in the test case suite comprises:
assigning a random number of the test cases in a plurality of test cases to the test case suite.

13. The method of claim 1 wherein performing the similarity analysis between the test features in the namespace and the test cases in the test case suite comprises:
calculating a number of elements in each row of the test case feature matrix data set, wherein the number of elements indicates feature representation by a respective test case.

14. The method of claim 13 further comprising:
determining the number of elements in the each row of the test case feature matrix data does not meet a threshold; and
determining there is inadequate feature coverage in the test cases in the test case suite.

15. The method of claim 13 further comprising:
determining the number of elements in the each row of the test case feature matrix data equals zero;
determining there is no feature coverage in the test cases in the test case suite; and
performing at least one of adding additional test cases to the test case suite and replacing at least one of the test cases in the test case suite with another at least one test case.

16. The method of claim 1 wherein performing the similarity analysis between the test features in the namespace and the test cases in the test case suite comprises:
identifying a quantity of test cases that should be in the subset of the test cases that provide the at least a portion of the test coverage.

17. The method of claim 16 further comprising:
sorting results of the similarity analysis to identify the most relevant test cases in the test case suite, and selecting the quantity of the top sorted most relevant test cases to be in the subset of the test cases; and
outputting the subset of the test cases.

18. The method of claim 17 wherein outputting the subset of the test cases comprises:
identifying an index associated with each of the top sorted most relevant test cases; and
mapping the index in the test case suite to the respective test case to identify each test case in
in a software test life cycle system; the subset of the test cases.

19. A system comprising:
at least one processing device comprising a processor coupled to a memory;
the at least one processing device being configured:
to identify, by a test case management system, a namespace for inclusion of test features required to provide test coverage in a software test life cycle system;
to create, by the test case management system, a test case feature matrix data set for test cases in a test case suite;
to perform a similarity analysis, by the test case management system, between the test features in the namespace and the test cases in the test case suite, using the test case feature matrix data set, to identify a subset of the test cases that provide at least a portion of the test coverage; and
to execute, by the software test life cycle system, the subset of the test cases on a test system to provide the at least a portion of the test coverage.

20. A computer program product comprising a non-transitory processor-readable storage medium having stored therein program code of one or more software programs, wherein the program code when executed by at least one processing device causes said at least one processing device:
to identify, by a test case management system, a namespace for inclusion of test features required to provide test coverage in a software test life cycle system;
to create, by the test case management system, a test case feature matrix data set for test cases in a test case suite;
to perform a similarity analysis, by the test case management system, between the test features in the namespace and the test cases in the test case suite, using the test case feature matrix data set, to identify a subset of the test cases that provide at least a portion of the test coverage; and
to execute, by the software test life cycle system, the subset of the test cases on a test system to provide the at least a portion of the test coverage.
